(19) United States
(12) Patent Application Publication
(10) Pub. No.: US 2025/0271647 A1
(43) Pub. Date: Aug. 28, 2025

(54) WIDE-ANGLE PHOTOGRAPHIC OBJECTIVE

(71) Applicant: Leica Camera AG, Wetzlar (DE)

(72) Inventor: Stefan ROTH, Lahnau (DE)

(21) Appl. No.: 19/050,695

(22) Filed: Feb. 11, 2025

(30) Foreign Application Priority Data
Feb. 28, 2024 (DE) 102024105587.1

(51) Int. Cl. G02B 13/06

(52) U.S. Cl. CPC G02B 13/06

(57) ABSTRACT

The invention relates to a wide-angle photographic objective consisting of a front group, a middle group and a rear group in an order from an object-side end to an image-side end. The front group comprises at least two outer lenses having a negative refractive power and at least two inner lenses having a positive refractive power that are arranged between the at least two outer lenses. The middle group consists of three lenses cemented together, of which two outer lenses have a positive refractive power and an inner lens arranged between the two outer lenses has a negative refractive power.

### CROSS-REFERENCES TO RELATED APPLICATIONS

This application claims the benefit of German Application No. 102024105587.1, filed Feb. 28, 2024. The entire disclosure of the application referenced above is incorporated herein by reference.

The present invention relates to a wide-angle objective for photographic applications.

Wide-angle objectives of the retrofocus type, comprising a front group having a negative refractive power and a rear group having a positive refractive power, are generally known.

Symmetrical objective designs are furthermore known that comprise a middle group having a positive refractive power as well as a front group and a rear group that each have a negative refractive power. Such designs are in particular suitable for mirrorless cameras.

Quasi-symmetrical designs, in which a front group, a middle group and a rear group that each have a positive refractive power are provided, are likewise known for the use at mirrorless cameras.

Very compact dimensions are only achieved by objectives that have a symmetrical or quasi-symmetrical design. In retrofocus designs, compact dimensions are not possible due to their principle. Furthermore, the correction of coma, distortion, and lateral chromatic aberration is only incomplete due to the asymmetrical design.

In general, high refractive powers are required in the individual elements in the design of compact wide-angle objectives. However, this leads to third-order and higher-order aberrations that result in uncorrected residual errors in the image, which has an unfavorable effect on the image contrast.

In compact wide-angle objectives, the correction of the image field curvature, of the astigmatism, of the distortion, and of the chromatic aberration is often only possible with restrictions. With particularly fast wide-angle objectives, the correction of the longitudinal chromatic aberration is additionally only possible to a limited extent.

A wide-angle photographic objective is known from DE 10 2018 132 472 A1, comprising a front group of positive total refractive power having four lenses, a middle group of positive total refractive power having three lenses and a rear group of positive total refractive power having three lenses. The lenses of the middle group are cemented together, wherein the two outer lenses have a positive refractive power and an inner lens has a negative refractive power. The outer lenses of the front group have a positive refractive power, while the inner lenses arranged therebetween have a negative refractive power.

The object of the invention is to provide a particularly fast wide-angle photographic objective that has compact dimensions and a high imaging performance with particularly small chromatic aberrations.

The object is satisfied by a wide-angle photographic objective having the features of claim 1. The wide-angle objective according to the invention comprises, in an order from an object-side end to an image-side end, a front group, a middle group and a rear group. The front group comprises at least two outer lenses having a negative refractive power and at least two inner lenses having a positive refractive power that are arranged between the at least two outer lenses. The middle group consists of three lenses cemented together, of which two outer lenses have a positive refractive power and an inner lens arranged between the two outer lenses has a negative refractive power. The front group is thus of symmetrical design, at least with respect to the order of refractive power ((−), (+), (+), (−)). A respective one of the outer lenses is preferably cemented to the respective adjacent inner lens to form a doublet.

Compared to known objective designs, the wide-angle objective according to the invention has very compact dimensions, in particular with respect to the overall length, and a very high light intensity.

According to an advantageous embodiment, the rear group comprises at least three lenses. Accordingly, the wide-angle objective therefore has a total of at least ten lenses. The last lens, i.e. the lens provided at the image-side end of the rear group, can have both a positive and a negative refractive power. Advantageously, the second-to-last lens of the rear group has a negative refractive power and the third-to-last lens of the rear group has a positive refractive power. The terms “last”, “second-last” and “third-last” each refer to the position of the lens in question in the initially mentioned order from the object-side end to the image-side end of the wide-angle objective.

According to a further advantageous embodiment, an aperture diaphragm is arranged between the front group and the middle group. The aperture diaphragm can in particular be designed as a settable aperture diaphragm.

According to a further advantageous embodiment, a last lens surface of the middle group is aspherical. This contributes to the correction of spherical aberration and coma. Alternatively or additionally, one lens surface of the last lens of the front group, which has a positive refractive power, is aspherical. This contributes to the correction of monochromatic aberrations, in particular spherical aberration and coma. Alternatively or additionally, at least one lens surface of the last lens of the rear group is aspherical. The aspherical design at one or both sides of the rearmost lens of the wide-angle objective effects a correction of monochromatic aberrations in the field, i.e. of monochromatic aberrations that increase with the increasing distance from the optical axis.

According to a further advantageous embodiment, at least one lens of the front group having a positive refractive power has a refractive index of greater than 1.95. This helps to minimize the Petzval sum and thus to reduce the image field curvature. Alternatively or additionally, at least one lens of the middle group having a positive refractive power has a refractive index of greater than 1.85. It is hereby possible to correct monochromatic aberrations. Alternatively or additionally, at least one lens of the rear group having a positive refractive power has a refractive index of greater than or equal to 1.9. This design likewise contributes to minimizing the Petzval sum and thus to reducing the image field curvature.

According to a further advantageous embodiment, at least one lens of the front group having a positive refractive power and/or at least one lens of the middle group having a positive refractive power has/have an Abbe number of greater than 47.5 and less than 60. Chromatic aberrations can be corrected by using glasses whose Abbe number lies in the mentioned range. Preferably, at least one of the lenses mentioned is aspherical. In particular, one or both lens surfaces of one or more of said lenses are aspherical. Monochromatic aberrations can hereby additionally be corrected.

According to a further advantageous embodiment, at least one lens of the middle group having a negative refractive power and/or the last lens of the front group that has a negative refractive power has/have a deviation of the relative partial dispersion ΔP_{g,F} from the normal line of greater than −0.0035 and less than +0.0010 and preferably has/have an Abbe number of greater than 25 and less than 35. For the aforementioned lenses having a negative refractive power, glasses with a negative or slightly positive deviation of the relative partial dispersion from the normal line and preferably also with a relatively low Abbe number are thus preferably used.

The relative partial dispersion P_{g,F} is defined by:

$${P}_{g , F} = \frac{{n}_{g} - {n}_{F}}{{n}_{F} - {n}_{C}} ,$$

where n_{F} is the refractive index at the Fraunhofer line F (wavelength 468.13 nm), n_{g} is the refractive index at the Fraunhofer line g (wavelength 435.83 nm), and n_{C} is the refractive index at the Fraunhofer line C (wavelength 656.28 nm).

The deviation of the relative partial dispersion ΔP_{g,F} from the normal line is defined by:

$$Δ {P}_{g , F} = {P}_{g , F} - ( 0 , 6438 - 0 , 001682 \cdot {υ}_{d} ) ,$$

where v_{d} is the Abbe number at the Fraunhofer line d (wavelength 587.56 nm).

Chromatic aberrations can be corrected by using glasses having one or more of the mentioned properties.

According to a further advantageous embodiment, the ratio of the total refractive power f′ₜₒₜ of the wide-angle objective to the refractive power f′_{VG} of the front group (VG) is greater than −0.15 and less than +0.15. It has been shown that the best possible correction of the astigmatic difference can take place in this way.

According to a further advantageous embodiment, the rear group is formed as a floating element that is preferably shifted in the same direction with the front group and the middle group during the focusing, with the shifting distance of the rear group, however, being smaller than the shifting distance of the front group and of the middle group. The latter condition thus means that the adjustment path of the rear group is smaller during the focusing than the adjustment path of the total objective. A particularly good imaging performance at close range can hereby be achieved since the aberrations coma and astigmatism can be compensated. Alternatively, however, the objective can also be moved as a unit during the focusing, i.e. no relative movement of individual lenses or lens groups to one another is provided.

According to a further advantageous embodiment, the half angle of view amounts to between 30.1° and 33.3° and/or the relative aperture amounts to between 1:1.14 and 1:1.26.

According to a further advantageous embodiment, the ratio of the optical overall length to the total focal length of the objective is less than or equal to 2.1. The advantageous embodiments according to the invention contribute to a compact design of the total objective so that the ratio between the optical overall length and the total focal length can be reduced to or below the stated dimension of 2.1.

According to a further advantageous embodiment, the ratio of the geometric flux to the quotient of the optical overall length and the total focal length of the objective is greater than or equal to 0.18. The ability of the wide-angle objective to illuminate an image area with a high light intensity and compact dimensions of the objective is hereby described.

According to a further advantageous embodiment, the distance between the front group and the middle group can be changed. By appropriately selecting or adapting this distance when mounting the objective, the astigmatic difference can be minimized depending on the thickness of the cover glass used when using cover glasses for the image sensor of a connected camera. A setting option of this distance by the user does not have to be provided.

The lens surface following directly behind the aperture diaphragm, i.e. the front lens surface of the first lens of the middle group, can be selectively convexly or concavely curved or planar.

Particular advantages of the invention are the relatively small aperture diameter, which allows a design with a small outer diameter of the objective, and a good correction of the aberrations to which in particular the middle and rear group contribute. The position of the aspheres and the respective glass materials used for the various lenses with respect to their optical properties were selected such that the Petzval sum and thus the image field curvature as well as the monochromatic and chromatic image aberrations are minimized.

Further advantageous embodiments of the invention result from the dependent claims, from the description, and from the drawing, wherein individual features and/or feature groups can be combined with one another in a suitable manner—also in a manner differing from the feature combinations explicitly mentioned here.

The invention will be described below with reference to embodiment examples and to the drawings. There are shown:

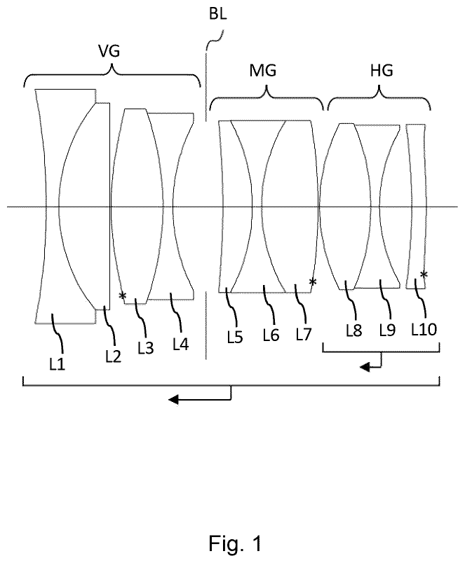

FIG. 1 a lens section of a wide-angle objective according to a first embodiment example;

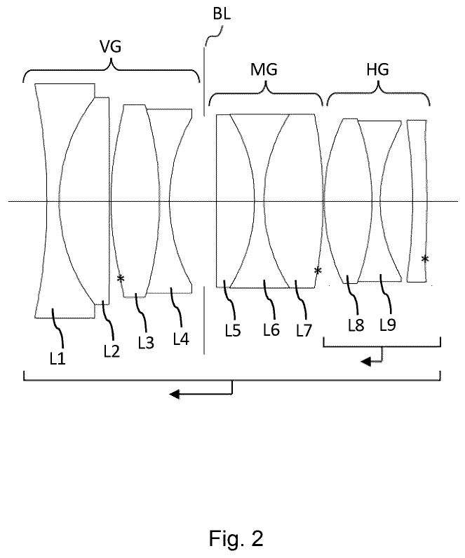

FIG. 2 a lens section of a wide-angle objective according to a second embodiment example; and

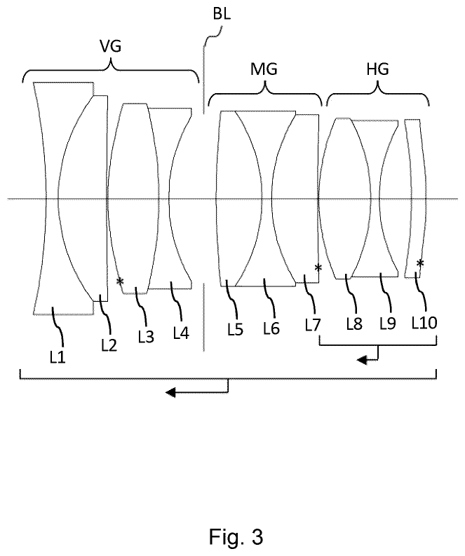

FIG. 3 a lens section of a wide-angle objective according to a third embodiment example.

FIGS. 1 to 3 each show a wide-angle photographic objective according to a first, second and third embodiment example having ten refractive lenses L1 to L10.

Those features which are realized in all three embodiment examples are first described below.

The lenses L1 to L10 are numbered in ascending order in a direction of light propagation of the optical path starting from the object side to the image side. Relative position indications such as “first”, “last”, “in front of” or “behind” relate to this order.

Each exemplary wide-angle objective comprises a front group VG that comprises the first to fourth lens L1 to L4; a middle group MG that comprises the fifth to seventh lens L5 to L7; and a rear group HG that comprises the eighth to tenth lens L8 to L10.

The first lens L1 having a negative refractive power and the second lens L2 having a positive refractive power are connected to form a cemented compound lens (doublet) and form a first subgroup G1. The third lens L3 having a positive refractive power and the fourth lens L4 having a negative refractive power are likewise connected to form a cemented compound lens (doublet) and form a second subgroup G2. The front group VG thus comprises the first and second subgroup G1, G2.

The fifth lens L5 having a positive refractive power, the sixth lens L6 having a negative refractive power, and the seventh lens L7 having a positive refractive power are connected to form a further cemented compound lens (triplet) and form a third subgroup G3. The middle group MG comprises or consists of the third subgroup G3.

The eighth lens L8 having a positive refractive power and the ninth lens L9 having a negative refractive power are connected to form a further cemented compound lens (doublet) and form a fourth subgroup G4. The tenth lens L10 having a negative refractive power is designed as a single lens and forms a fifth subgroup G5. The rear group HG comprises or consists of the fourth and fifth subgroups G4, G5.

An aperture diaphragm BL is arranged between the front group VG and the middle group MG.

The rear group HG is formed as a floating element and moves in the same direction with the residual objective, which is formed by the front group VG, the aperture diaphragm BL and the middle group MG, during the focusing, with the shifting distance and thus the adjustment path of the floating element or of the rear group HG, however, being smaller than the shifting distance or the adjustment path of the residual objective.

Detailed design data and optical data for the lens elements of the wide-angle objective are indicated in the following tables for three different embodiment examples. For reasons of comparability, the design data are standardized to a total focal length of the wide-angle objective of f=1 mm. When scaled to a sensor format of 24 mm×36 mm (35 mm format), the focal length is 35 mm.

The data relate to the surfaces that designate respective air-to-glass or glass-to-glass transitions and are numbered in ascending order from the object-side end to the image-side end. Thus, the surface 1 designates the object-side surface of the first lens L1, the surface 2 designates the common surface of the first and second lenses L1, L2, and so on. The last surface 16 is the image-side surface of the tenth lens L10. The surface 7 corresponds to the aperture diaphragm BL.

In a respective first table, for a respective refractive surface, r denotes the vertex radius, d_{M} the center thickness or the distance to an adjacent surface at the vertex, nₑ the refractive index for the Fraunhofer line e (wavelength 546.07 nm) and vₑ the Abbe number for the Fraunhofer line e. The specifications of the center thickness for the surfaces 11 and 16 are variable distances from the respective following surfaces that depend on the focus setting. The specified distances refer to a focusing at infinity.

The affiliations of the respective surfaces to the respective lenses L1-L10, to the subgroups G1-G5, and to the groups HG, MG and HG are likewise shown.

The object-side surface of the third lens L3 (surface 4) and the image-side surfaces of the seventh and tenth lenses L7 and L10 (surfaces 11 and 16) have an aspherical curvature and are marked with the symbol * in FIGS. 1 to 3. The following asphere equation applies to a sag z of a respective lens surface in parallel with the optical axis at a point having the height h with respect to the optical axis and perpendicular thereto:

$$z ( h ) = \frac{{h}^{2} / r 0}{1 + \sqrt{1 - ( 1 + k ) {( h / r 0 )}^{2}}} + a 2 \cdot {h}^{4} + a 3 \cdot {h}^{6} + … + a 6 \cdot {h}^{12} ,$$

where r0 is the vertex radius of curvature, k is the conical constant, and a2, a3, . . . , a6 are the aspherical coefficients.

In a respective second table, the coefficients k, a2 to a6 are specified for the three aspherical surfaces 4, 11 and 16:

In a respective third table, the total focal length fₜₒₜ, the light intensity or the minimum f-number F/#(maximum aperture) and the half diagonal angle of view are specified.

### FIRST EMBODIMENT EXAMPLE (FIG. 1)

| | R | Surface | d_{M} | | | | | | |
|---|---|---|---|---|---|---|---|---|---|
| Surface | [mm] | type | [mm] | nₑ | vₑ | ΔP_{gF} | Lens | Subgroup | Group |
| 1 | −2.521 | | 0.05 | 1.616 | 37 | 0.002 | L1/2 | G1 | VG |
| 2 | 0.672 | | 0.21 | 1.978 | 30 | 0.005 | | | |
| 3 | 65.583 | | 0.01 | | | | | | |
| 4 | 1.173 | K04 | 0.21 | 1.743 | 48 | −0.005 | L3/4 | G2 | |
| 5 | −1.176 | | 0.04 | 1.707 | 30 | 0.0003 | | | |
| 6 | 0.739 | | 0.14 | | | | | | |
| 7 | ∞ | Diaphragm | 0.07 | | | | | | |
| 8 | −3.415 | | 0.12 | 1.886 | 41 | −0.009 | L5/6/7 | G3 | MG |
| 9 | −0.733 | | 0.04 | 1.692 | 31 | 0.0003 | | | |
| 10 | 0.676 | | 0.23 | 1.743 | 48 | −0.005 | | | |
| 11 | −2.055 | K11 | 0.01 | | | | | | |
| 12 | 0.749 | | 0.21 | 1.920 | 36 | 0.001 | L8/9 | G4 | HG |
| 13 | −0.859 | | 0.04 | 1.661 | 33 | 0.009 | | | |
| 14 | 0.641 | | 0.13 | | | | | | |
| 15 | −2.394 | | 0.06 | 1.902 | 29 | 0.007 | L10 | G5 | |
| 16 | −2.626 | K16 | 0.44 | | | | | | |

| Surface | k | a2 | a3 | a4 | a5 | a6 |
|---|---|---|---|---|---|---|
| K04 | 0.000 | −0.4451 | −0.9275 | — | — | — |
| K11 | 0.000 | −0.0191 | −0.6942 | 3.4328 | — | — |
| K16 | 0.000 | 1.0073 | 0.0991 | 53.9141 | −283.5267 | 1057.9950 |

| | | Half angle |
|---|---|---|
| fₜₒₜ [mm] | F/# | of view [°] |
| 1 | 1.25 | 31 |

### SECOND EMBODIMENT EXAMPLE (FIG. 2)

| | | Surface | d_{M} | | | | | | |
|---|---|---|---|---|---|---|---|---|---|
| Surface | r[mm] | type | [mm] | nₑ | vₑ | ΔP_{gF} | Lens | Subgroup | Group |
| 1 | −2.355 | | 0.05 | 1.608 | 38 | 0.002 | L1/2 | G1 | VG |
| 2 | 0.699 | | 0.21 | 2.007 | 28 | 0.005 | | | |
| 3 | −45.068 | | 0.01 | | | | | | |
| 4 | 1.175 | K04 | 0.20 | 1.743 | 48 | −0.005 | L3/4 | G2 | |
| 5 | −1.347 | | 0.04 | 1.760 | 28 | 0.0003 | | | |
| 6 | 0.700 | | 0.14 | | | | | | |
| 7 | ∞ | Diaphragm | 0.05 | | | | | | |
| 8 | Plano | | 0.16 | 1.890 | 40 | −0.009 | L5/6/7 | G3 | MG |
| 9 | −0.675 | | 0.04 | 1.732 | 29 | 0.0003 | | | |
| 10 | 0.661 | | 0.24 | 1.743 | 48 | −0.005 | | | |
| 11 | −2.075 | K11 | 0.01 | | | | | | |
| 12 | 0.783 | | 0.20 | 1.945 | 33 | 0.001 | L8/9 | G4 | HG |
| 13 | −0.990 | | 0.04 | 1.644 | 34 | 0.009 | | | |
| 14 | 0.614 | | 0.13 | | | | | | |
| 15 | −2.289 | | 0.06 | 1.918 | 27 | 0.007 | L10 | G5 | |
| 16 | −2.673 | K16 | 0.44 | | | | | | |

| Surface | k | a2 | a3 | a4 | a5 | a6 |
|---|---|---|---|---|---|---|
| K04 | 0.000 | −0.4673 | −0.9672 | | | |
| K11 | 0.000 | −0.1578 | −0.6938 | 1.3729 | | |
| K16 | 0.000 | 1.0152 | −1.0694 | 70.2429 | −452.1379 | 1539.9660 |

| | | Half angle |
|---|---|---|
| fₜₒₜ [mm] | F/# | of view [°] |
| 1 | 1.24 | 32 |

### THIRD EMBODIMENT EXAMPLE (FIG. 3)

| | r | Surface | d_{M} | | | | | | |
|---|---|---|---|---|---|---|---|---|---|
| Surface | [mm] | type | [mm] | nₑ | vₑ | ΔP_{gF} | Lens | Subgroup | Group |
| 1 | −2.264 | | 0.05 | 1.607 | 38 | 0.002 | L1/2 | G1 | VG |
| 2 | 0.714 | | 0.20 | 2.012 | 28 | 0.005 | | | |
| 3 | 22.342 | | 0.01 | | | | | | |
| 4 | 1.089 | K04 | 0.21 | 1.741 | 48 | −0.005 | L3/4 | G2 | |
| 5 | −1.588 | | 0.04 | 1.815 | 26 | 0.0003 | | | |
| 6 | 0.684 | | 0.15 | | | | | | |
| 7 | ∞ | Diaphragm | 0.05 | | | | | | |
| 8 | 3.582 | | 0.19 | 1.886 | 41 | −0.009 | L5/6/7 | G3 | MG |
| 9 | −0.659 | | 0.04 | 1.644 | 34 | 0.0003 | | | |
| 10 | 0.665 | | 0.19 | 1.743 | 48 | −0.005 | | | |
| 11 | 12.963 | K11 | 0.01 | | | | | | |
| 12 | 0.844 | | 0.22 | 1.900 | 39 | 0.001 | L8/9 | G4 | HG |
| 13 | −0.714 | | 0.04 | 1.648 | 34 | 0.009 | | | |
| 14 | 0.641 | | 0.14 | | | | | | |
| 15 | −1.803 | | 0.06 | 1.905 | 38 | 0.007 | L10 | G5 | |
| 16 | −2.626 | K16 | 0.44 | | | | | | |

| Surface | k | a2 | a3 | a4 | a5 | a6 |
|---|---|---|---|---|---|---|
| K04 | 0.000 | −0.3783 | −0.8250 | | | |
| K11 | 0.000 | 0.1160 | −0.8264 | 4.7887 | | |
| K16 | 0.000 | 0.7701 | −0.1080 | 50.5825 | −309.9835 | 1417.2570 |

| | | Half angle |
|---|---|---|
| fₜₒₜ [mm] | F/# | of view [°] |
| 1 | 1.24 | 32 |

Further optical data and design data for the three embodiment examples are specified in the following table:

| Refractive | Embodiment | Embodiment | Embodiment |
|---|---|---|---|
| powers | example 1 | example 2 | example 3 |
| f′ₜₒₜ | 1.00 | 1.00 | 1.0 |
| f′_{VG} | 8.30 | 34.75 | −8.4 |
| f′_{MG} | 2.22 | 1.69 | 1.4 |
| f′_{HG} | 1.67 | 1.86 | 1.6 |
| Other paraxial | | | |
| and design data | | | |
| Optical overall | 1.99 | 2.01 | 2.05 |
| length SO′ [mm] | | | |
| Minimum f-number F/# | 1.25 | 1.24 | 1.24 |
| Image area A [mm²] | 0.70 | 0.70 | 0.70 |
| Geometric flux G | 0.35 | 0.36 | 0.35 |
| Other conditions | | | |
| G/(SO′/fₜₒₜ) | 0.18 | 0.18 | 0.18 |

Here, the optical overall length SO′ is the distance between the apex of the first lens and the image plane. The image area A results from the sensor area or image area (24 mm×36 mm) standardized according to the focal length ratio (1 mm:35 mm). For the geometric flux G, G=(π−A)/(2−F/#)² applies.

A significant difference between the three exemplary wide-angle objectives is that the surface 8 following directly behind the aperture diaphragm BL, i.e. the front lens surface of lens L5, is concave in the first embodiment example (FIG. 1), planar in the second embodiment example (FIG. 2) and convex in the third embodiment example (FIG. 3). A further difference is that the refractive power of the front group is positive in the first and second embodiment examples (FIGS. 1 and 2) and negative in the third embodiment example (FIG. 3).

Glass is the preferred lens material for all the lenses, wherein one or more lenses can, however, also be made of plastic.

The above-described design data and optical values of the embodiment examples of a wide-angle objective according to the invention are only exemplary. It is understood that wide-angle objectives having different design data and optical parameters can also be covered by the present invention. In particular, a different scaling to other focal lengths than 35 mm or other image formats can also take place.

Furthermore, in addition to the ten lenses mentioned by way of example, further lenses can also be provided. Thus, the front group VG and/or the rear group HG can, for example, each have a further lens having a positive or a negative refractive power at a suitable location. It is understood that the numbering of the lenses may shift accordingly in the case of such a modification.

### REFERENCE NUMERAL LIST

BL aperture diaphragm
L1-L10 first to tenth lens
G1-G5 first to fifth subgroup
VG front group
MG middle group
HG rear group

1. A wide-angle photographic objective consisting of a front group, a middle group and a rear group in an order from an object-side end to an image-side end,
wherein the front group comprises at least two outer lenses having a negative refractive power and at least two inner lenses having a positive refractive power that are arranged between the at least two outer lenses, wherein the middle group consists of three lenses cemented together, of which two outer lenses have a positive refractive power and an inner lens arranged between the two outer lenses has a negative refractive power.

2. The wide-angle objective according to claim 1,
wherein the rear group comprises at least three lenses.

3. The wide-angle objective according to claim 2,
wherein the second-last lens of the rear group has a negative refractive power and the third-last lens of the rear group has a positive refractive power.

4. The wide-angle objective according to claim 1,
wherein an aperture diaphragm is arranged between the front group and the middle group.

5. The wide-angle objective according to claim 1,
wherein
a last lens surface of the middle group, and/or
a lens surface of the last lens of the front group having a positive refractive power, and/or
at least one lens surface of the last lens of the rear group is aspherical.

6. The wide-angle objective according to claim 1,
wherein at least one lens of the front group having a positive refractive power has a refractive index of greater than 1.95.

7. The wide-angle objective according to claim 1,
wherein at least one lens of the middle group having a positive refractive power has a refractive index of greater than 1.85.

8. The wide-angle objective according to claim 1,
wherein at least one lens of the rear group having a positive refractive power has a refractive index of greater than or equal to 1.9.

9. The wide-angle objective according to claim 1,
wherein at least one lens of the front group having a positive refractive power and/or at least one lens of the middle group having a positive refractive power has/have an Abbe number of greater than 47.5 and less than 60 and preferably has/have an aspherical surface.

10. The wide-angle objective according to claim 1,
wherein at least one lens of the middle group having a negative refractive power and/or the last lens of the front group that has a negative refractive power has/have a deviation of the relative partial dispersion ΔP_{g,F} from the normal line of greater than −0.0035 and less than +0.0010.

11. The wide-angle objective according to claim 10,
wherein at least one lens of the middle group having a negative refractive power and/or the last lens of the front group that has a negative refractive power has/have an Abbe number of greater than 25 and less than 35.

12. The wide-angle objective according to claim 1,
wherein the ratio of the total refractive power f′ₜₒₜ of the wide-angle objective to the refractive power f′_{VG} of the front group is greater than −0.15 and less than +0.15.

13. The wide-angle objective according to claim 1,
wherein the rear group is formed as a floating element, with the shifting distance of the rear group, however, being smaller than the shifting distance of the front group and of the middle group.

14. The wide-angle objective according to claim 13,
wherein the rear group is shifted in the same direction with the front group and the middle group during the focusing.

15. The wide-angle objective according to claim 1,
wherein the half object angle amounts to between 30.1° and 33.3°.

16. The wide-angle objective according to claim 1,
wherein the relative aperture amounts to between 1:1.14 and 1:1.26.

17. The wide-angle objective according to claim 1,
wherein the ratio of the optical overall length SO′ to the total focal length fₜₒₜ of the wide-angle objective is less than or equal to 2.1.

18. The wide-angle objective according to claim 1,
wherein the ratio of the geometric flux G to the quotient of the optical overall length SO′ and the total focal length fₜₒₜ of the wide-angle objective is greater than or equal to 0.18.
